(19) United States
(12) Patent Application Publication
(10) Pub. No.: US 2015/0326432 A1
(43) Pub. Date: Nov. 12, 2015

(54) ENVIRONMENT CONFIGURATION SERVER, COMPUTER SYSTEM, AND ENVIRONMENT CONFIGURATION METHOD

(71) Applicant: HITACHI, LTD., Chiyoda-ku, Tokyo (JP)

(72) Inventors: Satoshi FUJIE, Tokyo (JP); Nobuyuki SAIKA, Tokyo (JP); Hitoshi ARAI, Tokyo (JP)

(21) Appl. No.: 14/760,043

(22) PCT Filed: Jan. 24, 2013
(86) PCT No.: PCT/JP2013/051391

§ 371 Date: Jul. 9, 2015

(51) Int. Cl. H04L 12/24; H04L 29/08

(52) U.S. Cl. CPC H04L 41/0806; H04L 41/0859; H04L 67/1097; H04L 67/06

(57) ABSTRACT

In a computer system having a plurality of local file servers present in a local system, and a remote file server present in a remote system and coupled to the plurality of local file servers, an environment configuration server is provided in the remote system. The environment configuration server identifies, from a storage device storing environment configuration information regarding an environment configuration for each of the plurality of local file servers, environment configuration information corresponding to a configuration-target local file server of the plurality of local file server, and transmits the identified environment configuration information to the configuration-target local file server.

### TECHNICAL FIELD

The present invention relates to a technique for configuring environments for a plurality of file servers.

### BACKGROUND ART

Conventionally, companies and individuals have commonly purchased and utilized servers and software at their own expenses. However, for a reduction in total cost of ownership (TCO), cloud computing tends to prevail which utilizes severs and software via the Internet.

For example, a computer system is known in which file servers (local file servers) at a plurality of hubs (hereinafter referred to as edges) are coupled to a file server (remote file server) at a data center (hereinafter referred to as a core). In the computer system, a file at an edge is copied to the core, and the copied file is stubbed for management at the edge. Furthermore, when the stubbed file at the edge is accessed, the file is read on the core side.

In such a computer system, if a new local server is added to the edge or an environment configuration for the local file server at the edge are changed, an administrator of the edge configures the environment for the local file server. Here, the environment configuration refers to various basic configurations, for example, a network configuration and a file system creation configuration which allow a client (end user) at the edge to receive file-sharing service from the local file server.

When the environment configuration for the local file server is completed, the client can utilize the file-sharing service provided by the local file server.

As a technique for environment configuration, for example, a technique in PTL 1 is known.

### CITATION LIST

### Patent Literature

### [PTL 1]

Japanese Patent Application Laid-Open No. 2011-150587

### SUMMARY OF INVENTION

### Technical Problem

Conventional computer systems disadvantageously require high introduction costs. Specifically, a large number of edges lead to the need to configure the environment for the local file server at each edge, then this disadvantageously requires much time and effort. Furthermore, a large number of edges lead to the need to configure the environment at each edge, increasing the possibility of configuration errors.

Another problem with the conventional computer systems is that when the computer systems are in operation, operation level varies among the systems. Specifically, for example, when a plurality of edges is managed by different administrators, for example, particular edges may be intensively used though other edges have sufficient available capacities, thus, at these particular edges, the usage of a file system may increase to the extent that the edge is difficult to continue to operate.

### Solution to Problem

In a computer system including a plurality of local file servers present in a local system, and a remote file server present in a remote system and coupled to the plurality of local file servers, an environment configuration server is provided in the remote system. The environment configuration server identifies, from a storage device storing environment configuration information regarding an environment configuration for each of the plurality of local file servers, environment configuration information corresponding to a configuration-target local file server of the plurality of local file server, and transmits the identified environment configuration information to the configuration-target local file server. The configuration-target local file server can configure an environment based on the received environment configuration information.

### Advantageous Effects of Invention

According to the present invention, the environment configuration server can allow each local file server to configure an environment, therefore, this enables a reduction in the introduction cost of a computer system and in a variation in operation level among computer systems during operation.

### BRIEF DESCRIPTION OF DRAWINGS

FIG. 1 is a diagram of a hardware configuration of a computer system according to an embodiment.

FIG. 2 is a diagram of a hardware configuration of the computer system according to the embodiment.

FIG. 3 is a diagram of a software configuration of the computer system according to the embodiment.

FIG. 4 is a diagram of a configuration of an exemplary edge node management table according to the embodiment.

FIG. 5 is a diagram showing an example of a status of a computer system after completion of environment configuration according to the embodiment.

FIG. 6 is a diagram illustrating a configuration template and configuration information according to the embodiment.

FIG. 7 is a diagram showing reporting information according to the embodiment.

FIG. 8 is a diagram schematically illustrating a provisioning request process according to the embodiment.

FIG. 9 is a diagram schematically illustrating a reporting process according to the embodiment.

FIG. 10 is a diagram schematically illustrating a process into which the reporting process and the provisioning request process according to the embodiment are combined.

FIG. 11 is a flowchart of the provisioning request process carried out by the edge node according to the embodiment.

FIG. 12 is a flowchart of the reporting process carried out by the edge node according to the embodiment.

FIG. 13 is a flowchart of a configuration process carried out by a core node according to an embodiment.

FIG. 14 is a flowchart of a configuration control process carried out by a provisioning server according to the embodiment.

### DESCRIPTION OF EMBODIMENT

An embodiment will be described below. The embodiment described below is not intended to limit the invention according to the claims. Furthermore, not all elements described in the embodiment and combinations of the elements are essential for a solution provided by the invention.

Various types of information will sometimes be described below using an expression “aaa tables”. However, the various types of information may be expressed by a data structure other than the table. The various types of information can be referred to as “aaa information” instead of the “aaa table” so as to indicate that the information does not depend on the data structure.

In the description below, a “program” is sometimes used as a subject. However, a program is executed by a processor (typically a central processing unit (CPU)) to carry out a specified process using a memory and an interface (a NIC or the like), and thus, the processor may be used as a subject in the description. Furthermore, a process disclosed using the program as a subject may be a process carried out by a provisioning server or a file server. Additionally, a part or all of the program may be implemented by dedicated hardware. In addition, various programs may be installed in computers via a program distribution server or a computer readable storage medium.

Now, various terms will be described. A “core” refers to a hub (consolidated hub) including a remote computer system, for example, a hub that integrally manages a server and a storage apparatus or a hub that provides cloud service (for example, a data center). An “edge” refers to a hub including a local computer system, for example, a branch office, a business office, or a remote office where users actually perform operations. A “stub” refers to an object (metadata) with which file storage destination information (information indicative of a link destination) is associated. A stubbed file holds no actual data, and thus, when accessed, needs to acquire actual data from the computer system at the core. Hence, accesses to the stubbed file involve degraded access performance compared to accesses to normal files.

“Replication” refers to copying of a file present at the edge to the core. “Migration” refers to replication, at the core, of a file present at the edge and stubbing of the file from the edge. “Stubbing” refers to removal of actual data from a file in a file system at the edge (the computer system at the edge) so that the file holds only management information. “Archiving” collectively means migration and replication.

First, a computer system according to an embodiment will be described.

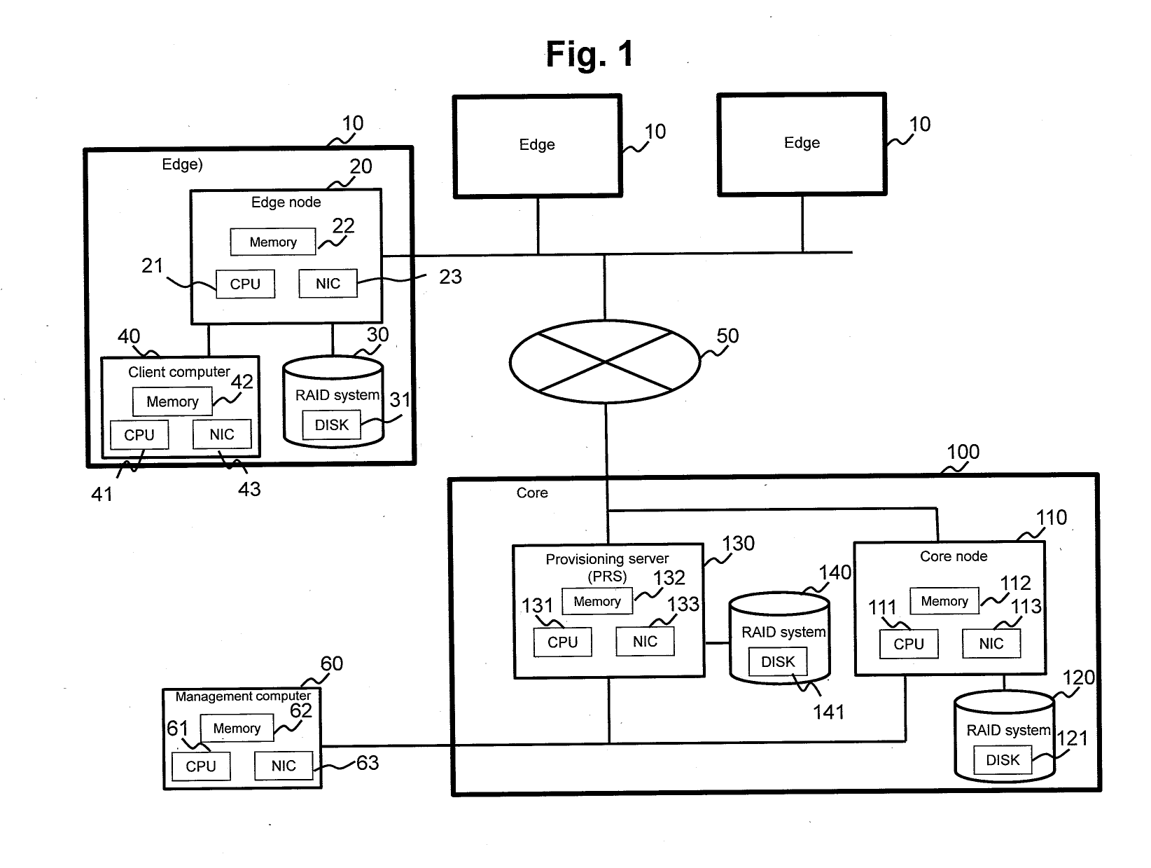

FIG. 1 is a diagram showing a hardware configuration of the computer system according to the embodiment.

The hardware of the computer system is arranged in a plurality of edges 10 and a core 100.

The computer system at the edge 10 includes a redundant array of independent (or inexpensive) disks (RAID) system 30, one or more edge nodes 20, and one or more client computers 40. The edge node 20 is an example of a local file server. The edge node 20 is coupled to a client computer 40, for example, via a communication network (for example, a local area network (LAN)). Furthermore, the edge node 20 is coupled to the RAID system 30, for example, via a communication network (for example, a storage area network (SAN)).

The RAID system 30 is a storage apparatus configured to store data in accordance with RAID rules. Another type of storage apparatus may be adopted instead of the RAID system 30. The RAID system 30 includes a DISK 31. The DISK 31 is a disk-like physical storage device (for example, a hard disk drive (HDD)). As the physical storage device, another type of physical storage device (for example, a flash memory device) may be adopted. Furthermore, the single DISK 31 is shown in FIG. 1, but in actuality, a plurality of DISKs 31 is provided (a single DISK 31 may be provided as shown in FIG. 1). One or more RAID groups may be formed of a plurality of DISKs 31. Furthermore, although not shown in the drawings, the RAID system 30 has a memory configured to store programs executed in the RAID system 30 and a central processing unit (CPU) which executes the programs.

The RAID system 30 receives a block-level I/O request transmitted by the edge node 20, and carries out an I/O operation on the appropriate DISK 31.

The edge node 20 includes a memory 22, a CPU 21, a network interface card (NIC) 23. The CPU 21 is coupled to the memory 22 and the NIC 23.

The NIC 23 is a communication interface device that communicates with a core node 110, the client computer 40, and a PRS 130. Instead of the NIC 23, another type of communication interface may be adopted.

The memory 22 is a storage area (for example, a random access memory (RAM) or a read only memory (ROM)) on which the CPU 21 can directly perform read and write operations. In the edge node 20, a program (for example, an operating system (OS)) for controlling the edge node 20 is read onto the memory 22 and executed by the CPU 21. The edge node 20 may have another type of storage resource in addition to or instead of the memory 22. The memory 22 is an example of storage device.

The edge node 20 receives a file-level I/O request from the client computer 40 via the NIC 23. The edge node 20 creates an I/O request (block-level I/O request) for I/O of a data block included in a file specified in the received I/O request. The edge node 20 transmits the block-level I/O request to the RAID system 30.

The client computer 40 is an example of a computer used by a client (user) and includes a memory 42, a CPU 41, and a NIC 43. The client computer 40 may have another type of storage resource in addition to or instead of the memory 42.

The client computer 40 reads a program (a program that controls the client computer 40 (for example, an OS)) onto the memory 42, and the CPU 41 executes the program. The client computer 40 transmits a file-level I/O request to the edge node 20 via the NIC 43.

A computer system at the core 100 includes a core node 110, a RAID system 120, the provisioning server (hereinafter referred to as the PRS) 130, and a RAID system 140. The core node 110 is an example of a remote file server and is specifically, for example, an archive file server. The RAID system 120 is coupled to the core node 110.

The RAID system 120 includes a DISK 121. In FIG. 1, the configuration of the RAID system 120 is identical to the configuration of the RAID system 30. Thus, the RAID system 120 also receives a block-level I/O request transmitted by the core node 110, and performs an I/O operation on the appropriate DISK 121. The configuration of the RAID system 120 may be different from the configuration of the RAID system 30.

The core node 110 includes a memory 112, a CPU 111, and a NIC 113. Instead of or in addition to the memory 112, another type of storage resource may be provided. In the core node 110, a program (for example, an OS) for controlling the core node 110 is read onto the memory 112, and the CPU 111 executes the program. Furthermore, the core node 110 communicates with the edge node 20 and the PRS 130 via the NIC 113 and a communication network 50. The core node 110 accesses the RAID system 120 in units of blocks.

The RAID system 140 includes a DISK 141. In FIG. 1, the configuration of the RAID system 140 is identical to the configuration of the RAID system 30. Thus, the RAID system 140 also receives a block-level I/O request transmitted by the PRS 130, and performs an I/O operation on the appropriate DISK 141. The configuration of the RAID system 140 may be different from the configuration of the RAID system 30.

The PRS 130 is an example of an environment configuration server, and includes a memory 132, a CPU 131, and a NIC 133. Instead of or in addition to the memory 132, another type of storage resource may be provided. The PRS 130 reads a program that controls the PRS 130 (for example, an OS) onto the memory 132, and the CPU 131 executes the program. Furthermore, the PRS 130 communicates with the edge node 20 via the NIC 133 and the communication network 50. The PRS 130 also communicates with the core node 110 via the NIC 133 and a communication network. The PRS 130 accesses the RAID system 140 in units of blocks. One or more NICs 133 are provided.

A management computer 60 may be coupled to the PRS 130 and the core node 110 via a communication network. The management computer 60 is an example of a computer used by an administrator to provide various configurations and the like for the PRS′130 and the core node 110. The management computer 60 includes a memory 62, a CPU 61, and a NIC 63. The management computer 60 reads a program that controls the management computer 60 (for example, an OS) onto the memory 62, and the CPU 61 executes the program. The management computer 60 also communicates with the PRS 130 and the core node 110 via the NIC 63 and a communication network.

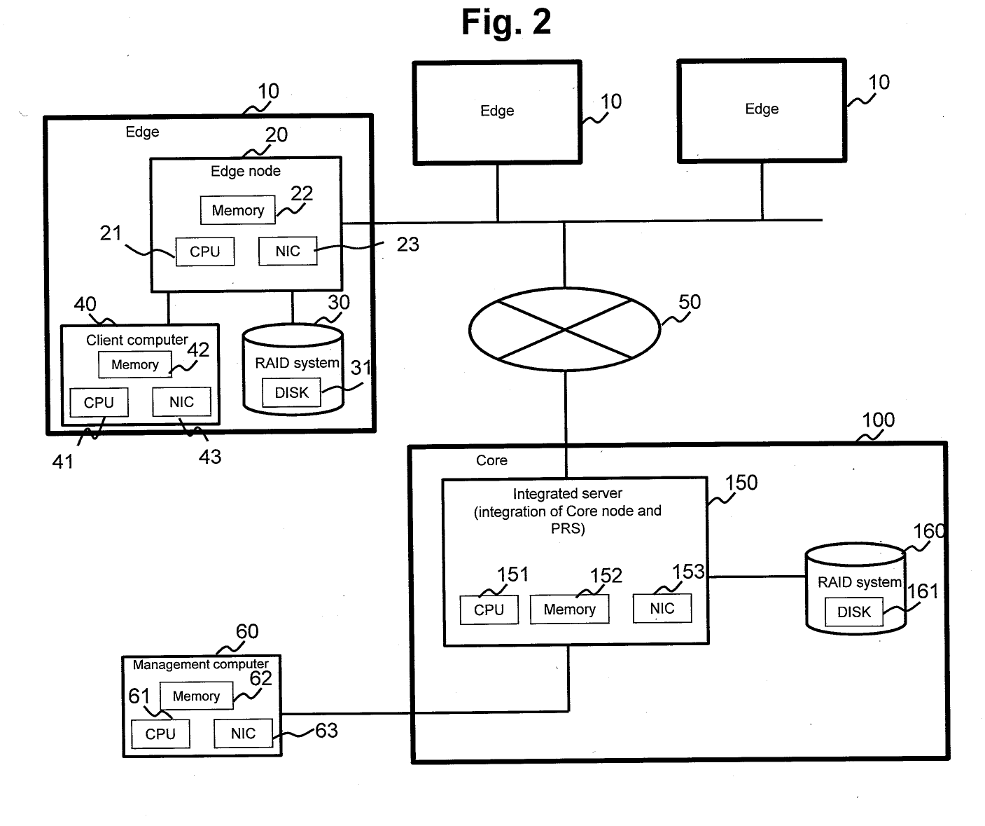

The computer system at the core 110 may be configured as follows. That is, the core node 110 and PRS 130 shown in FIG. 1 may be replaced with an integrated server 150 formed of a single computer as shown in FIG. 2. Alternatively, both the RAID system 120 and RAID system 140 shown in FIG. 1 may be integrated into a RAID system 160. This eliminates the need to physically separate the core node 110 and the PRS 130 from each other (for example, separate computers need not be provided).

The integrated server 150 includes a memory 152, a CPU 151, and a NIC 153, and implements the functions of the core node 110 and the PRS 130 shown in FIG. 1. Instead of or in addition to the memory 152, another type of storage resource may be provided. The integrated server 150 reads a program that controls the integrated server 150 (for example, an OS) onto the memory 152, and the CPU 151 executes the program. Furthermore, the integrated server 150 communicates with the edge node 20 via the NIC 153 and the communication network 50. The integrated server 150 accesses the RAID system 160 in units of blocks.

“Server” according to the present embodiment may be a physical server or a virtual server. The physical server may be one or more computers or storage apparatuses.

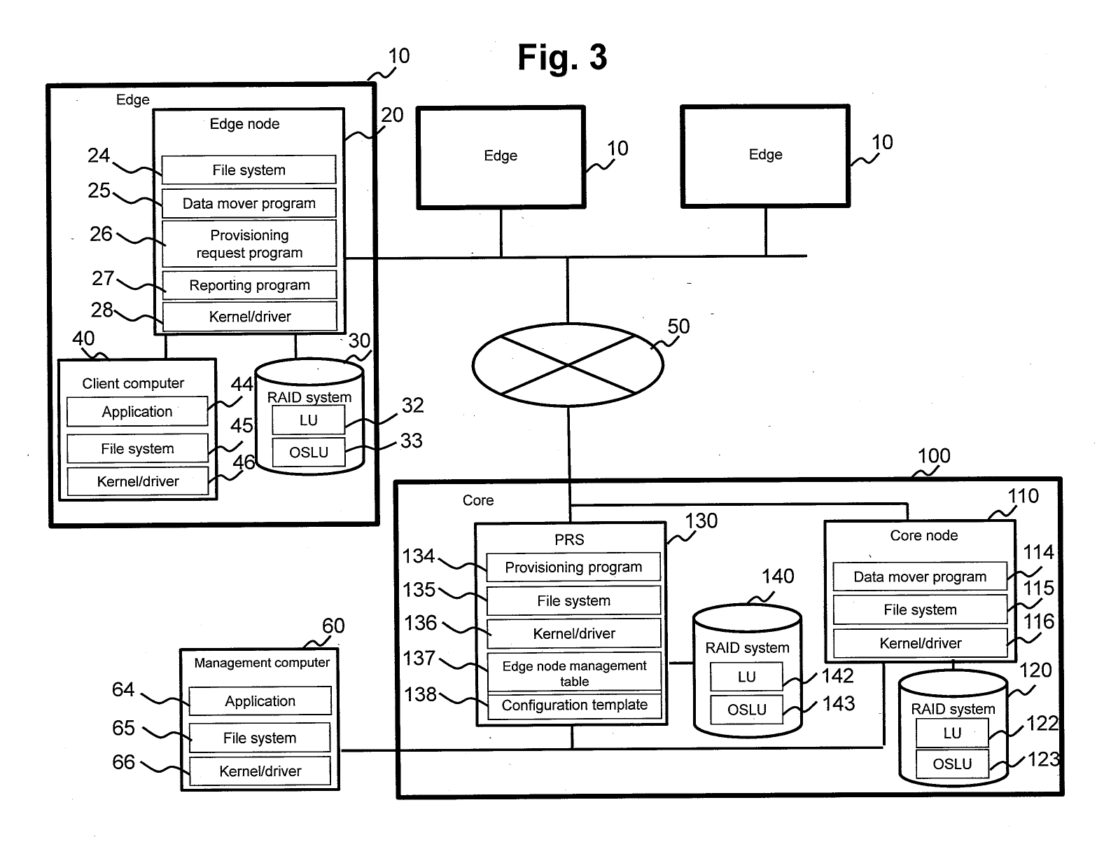

FIG. 3 is a diagram of a software configuration of the computer system according to the embodiment.

The RAID system 30 (120, 140) has a plurality of logical units (LUs) 32 (122, 142), and a logical unit for the OS (OS LU) 33 (123, 143). The LU 32 (122, 142) is a logical storage device provided for a higher device such as the edge node 20 (core node 110, the PRS 130). The LU 32 (122, 142) is created based on a storage area in the DISK 31 (121, 141). The LU 32 (122, 142) may be a substantive LU based on one or more DISKs 31 (121, 141) or a virtual LU in accordance with thin provisioning. The LU 32 (122, 142) is formed of a plurality of blocks (storage areas). A file is stored at the LU 32 (122, 142).

The OS LU 33 (123, 143) is a logical storage device. The OS LU 33 (123, 143) may be a substantive LU based on one or more DISKs 31 (121, 141). For example, programs that control the edge node 20, the core node 110, and the PRS 130 may be stored in the OS LU 33 (123, 143).

The memory 22 at the edge node 20 (the memory 112 in the core node 110) is configured to store a data mover program 25 (114), a file system 24 (115), and a kernel/driver 28 (116). The memory 22 at the edge node 20 is further configured to store a provisioning request program 26 and a reporting program 27. The data mover program 25 in the edge node 20 is hereinafter referred to as a “local mover”. The data mover program 114 in the core node 110 is hereinafter referred to as a “remote mover”. If the data mover programs 25 and 114 are not distinguished from each other, these programs are referred to as a “data mover program”. Files are transmitted and received between the edge node 20 and the core node 110 via the local mover 25 and the remote mover 114.

The local mover 25 reads a replication target file from the LU 32 in the RAID system 30, and transfers the file to the core node 110. The remote mover 114 receives the replication target file from the edge node 20, and writes the file to the LU 122 in the RAID system 120.

Furthermore, the local mover 25 removes the replicated file in the LU 32 (strictly speaking, the actual data in the file) if a certain condition is met, thus implementing substantial migration of the replicated file. Subsequently, if the local mover 25 receives a read request from the client computer 40 for reading of stub (metadata) from the file from which the actual data has been removed, the local mover 25 acquires, via the remote mover 114, a file (actual data in the file) linked with the stub. The local mover 25 then transmits the acquired file to the client computer 40.

The kernel/driver 28 (116) performs general control and control specific to the hardware such as control of scheduling of a plurality of programs (processes) operating on the edge node 20 (core node 110) and handling of interrupts from the hardware.

The provisioning request program 26 carries out a provisioning request process of acquiring environment configuration information from the PRS 130 and configuring the information. The reporting program 27 carries out a reporting process of transmitting a report on the status of the edge node 20 to the PRS 130.

The file system 24 (115) is a file system program and manages file system configuration information. The file system configuration information includes information on each file and directory (for example, information indicative of the size and location of a file). The file system configuration information is stored in, for example, the OS LU 33 (123) or the memory 22 (112).

The memory 42 in the client computer 40 is configured to store an application 44, a file system 45, and a kernel/driver 46.

The application 44 is software (application program) used by the client computer 40 in accordance with the purpose of an operation. The file system 45 and the kernel/driver 46 are almost similar to the above-described file system 24 (115) and kernel/driver 28 (116).

The memory 132 in the PRS 130 is configured to store a provisioning program 134, a file system 135, a kernel/driver 136, an edge node management table 137, and a configuration template 138.

The provisioning program 134 carries out a provisioning process of configuring an environment for the edge node 20 and/or the core node 110. The file system 135 and the kernel/driver 136 are almost similar to the above-described file system 24 (115) and kernel/driver 28 (116).

The edge node management table 137 manages information on each of the edge nodes 20 in the computer system. The edge node management table 137 will be described below in detail. The configuration template 138 is a configuration template (hereinafter simply referred to as a template) showing items required to configure an environment for the edge node 20. The configuration template 138 may include a plurality of templates with different items based on various perspectives. For example, a certain template may emphasize migration, and a certain template may emphasize archiving. Furthermore, a certain template may have only all items required for environment configuration and a certain template may be an intermediate template in which a common value is configured for some of the plurality of items.

The memory 62 in the management computer 60 is configured to store an application 64, a file system 65, and a kernel/driver 66.

The application 64 is software (application program) used by the management computer 60 in accordance with the purpose of an operation. According to the present embodiment, the application 64 accepts environment configuration information input by the administrator and which is to be configured for the edge node 20, for example, based on information from the PRS 130. For example, the application 64 accepts, from the administrator, values for those items in the configuration template 138 which correspond to a configuration-target edge node 20. Thus, since the values for those items in the configuration template 138 which correspond to the edge node 20 are accepted from the administrator, the values to be configured for the edge node 20 can be appropriately accepted. The file system 65 and kernel/driver 66 in the management computer 60 are almost similar to the above-described file system 24 (115) and kernel/driver 28 (116).

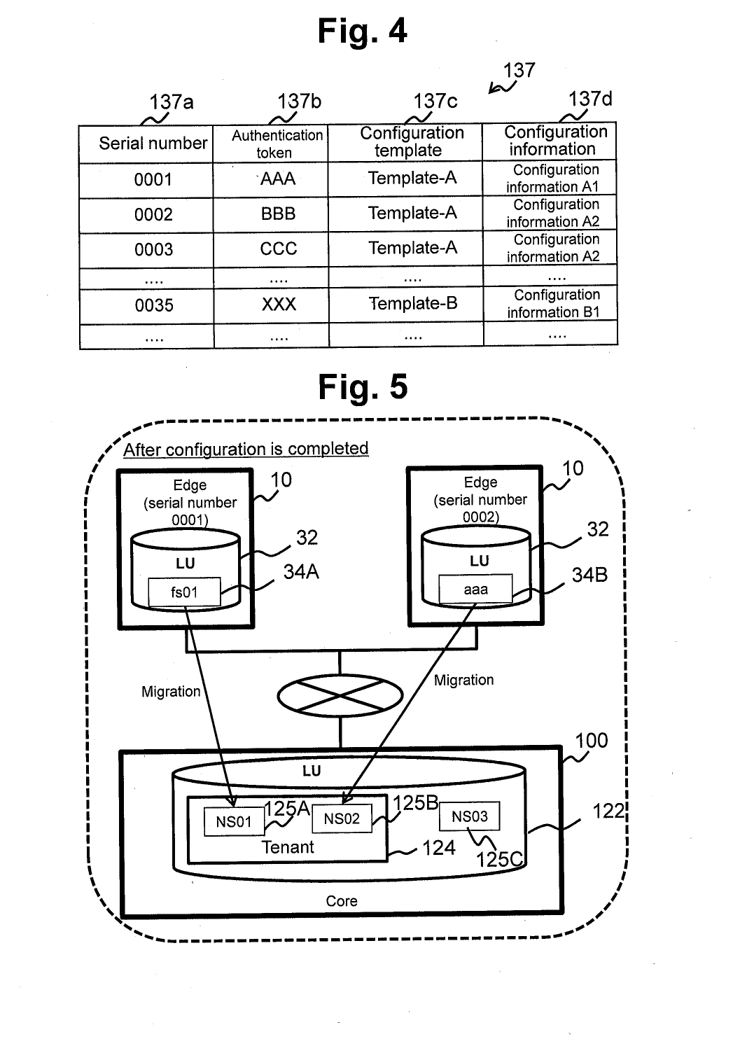

FIG. 4 is a diagram of a configuration of an exemplary edge node management table according to the embodiment.

The edge node management table 137 is a table for management of each edge node 20 and is configured to store entries including fields for a serial number 137a, an authentication token 137b, a configuration template 137c, and configuration information 137d.

Identification information (serial number) which identifies the edge node 20 is stored in the serial number 137c. In the authentication token 137b, an authentication token used for the edge node 20 corresponding to the entry is configured. The authentication token is acquired and configured during initialization for allowing communication with the edge node 20′. A pointer is stored in the configuration template 137c and used to refer to a template showing items required to configure environment configuration information for the edge node 20 corresponding to the entry in the configuration template 137c. A pointer is stored in the configuration information 137d and used to refer to environment configuration information (also simply referred to as configuration information) configured based on the template corresponding to the entry in the configuration information 137d. The configuration information indicated by the pointer is stored, for example, in the RAID system 30.

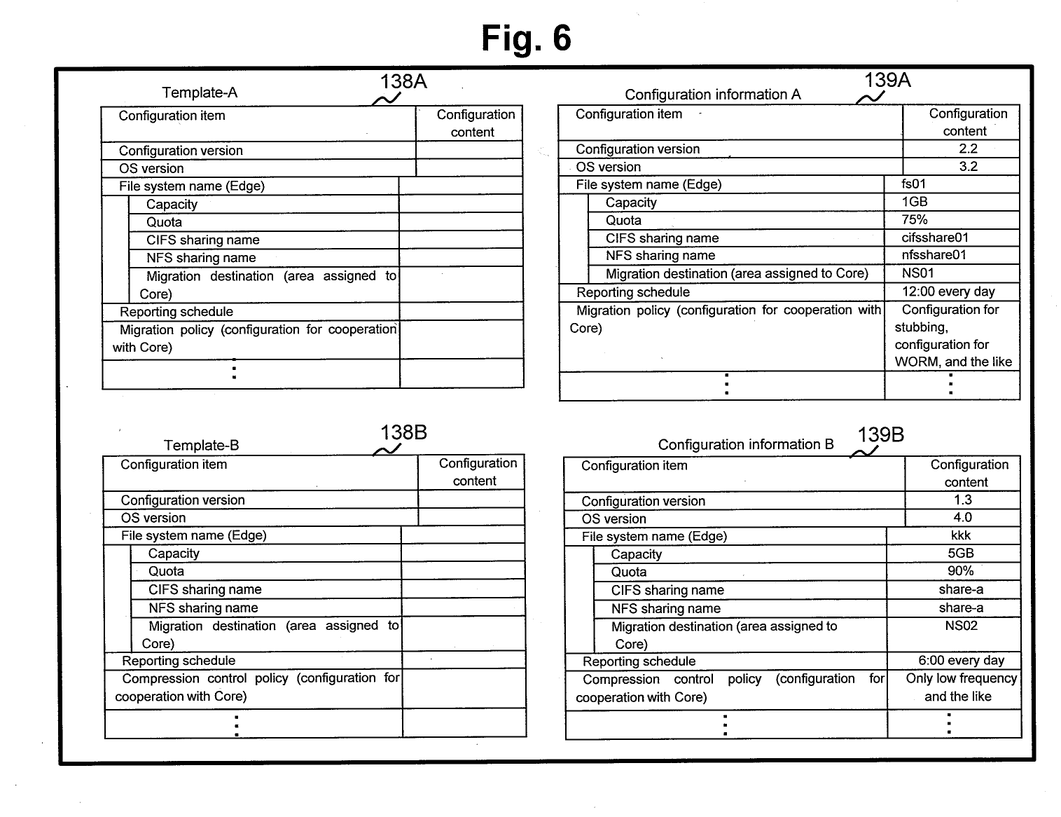

FIG. 6 is a diagram illustrating a configuration template according to the embodiment and configuration information.

The configuration template 138 may be, for example, a template 138A (template A) or a template 138B (template B).

The template 138A includes configuration items such as a configuration version, an OS version, a file system name (edge), capacity, quota, a common internet file system (CIFS) sharing name, a network file system (NFS) sharing name, a migration destination (an area assigned to the core), a reporting schedule, and a migration policy (a configuration for cooperation with the core). The template 138B includes configuration items such as a configuration version, an OS version, a file system name (edge), capacity, quota, a CIFS sharing name, an NFS sharing name, a migration destination (an area assigned to the core), a reporting schedule, and a compression control policy. These configuration items may be subjected to an addition/change in association with an addition/change of a function of the edge node and/or the core node.

The configuration version is the version of configuration information. The OS version is the version of the OS. The file system name (edge) is the name of the file system at the edge node 20. The capacity is the capacity of the file system. The quota is a threshold for the capacity of the file system. The CIFS sharing name is the sharing name used in the CIFS. The NFS sharing name is the sharing name used in the NFS. The migration destination (the area assigned to the core) is an area of the core node 110 to which a file in the file system is migrated. The reporting schedule is a schedule for execution of a reporting process. The migration policy (the configuration for cooperation with the core) is a policy for migration. Examples of the migration policy include a stubbing configuration that allows a file to be stubbed and a write once read many (WORM) configuration that allows migration to WORM. The compression policy is a policy regarding compression of files.

When values are configured for the configuration items in the template A, for example, the results of the configuration are as shown in, for example, configuration information 139A (configuration information A). The configuration information 139A is as follows. The configuration version is “2.2”, the OS version is “3.2”, the file system name is “fs01”, the capacity is “1 GB”, the quota is “75%”, the CIFS sharing name is “cifsshare01”, the NFS sharing name is “nfsshare01”, the migration destination is “NS01”, the reporting schedule is “12:00 every day”, and the migration policy is the “stubbing configuration” and the “WORM configuration”.

When values are configured for the configuration items in the template B, for example, the results of the configuration are as shown in, for example, configuration information 139B (configuration information B). The configuration information 139B is as follows. The configuration version is “1.3”, the OS version is “4.0”, the file system name is “aaa”, the capacity is “5 GB”, the quota is “90%”, the CIFS sharing name is “share-a”, the NFS sharing name is “share-a”, the migration destination is “NS02”, the reporting schedule is “6:00 every day”, and the compression control policy is “only low frequency” meaning that only infrequently accessed files are compressed.

FIG. 5 is a diagram showing an example of the status of the computer system after completion of environment configuration according to the embodiment. FIG. 5 shows the status of the computer system resulting from environment configuration for the edge node 20 based on configuration information A and configuration information B shown in FIG. 6.

A file system 34A with a file system name “fs01” is created in the LU 32 at one of the edges 10 in the computer system. A file system 125A named “NS01” to which a file in the file system 34A named “fs01” is to be migrated is created in the LU 122 at the core 100. Furthermore, a file system 34B with a file system name “aaa” is created in the LU 32 at another edge 10 in the computer system. A file system 125B named “NS02” to which a file in the file system 34B named “aaa” is to be migrated is created in the LU 122 at the core 100. If a file system to be created is already present, the existing file system is utilized to link the file system the edge with the migration destination. According to the present embodiment, a partial area (tenant 124: a sub-storage area) of the LU 122 is assigned to an identical organization (for example, one company). File systems (for example, 125A and 125B) corresponding to the migration destinations of the edges of the identical organization are created in the identical tenant 124. A file system (for example, 125C) for another organization is created in an area other than the tenant 124.

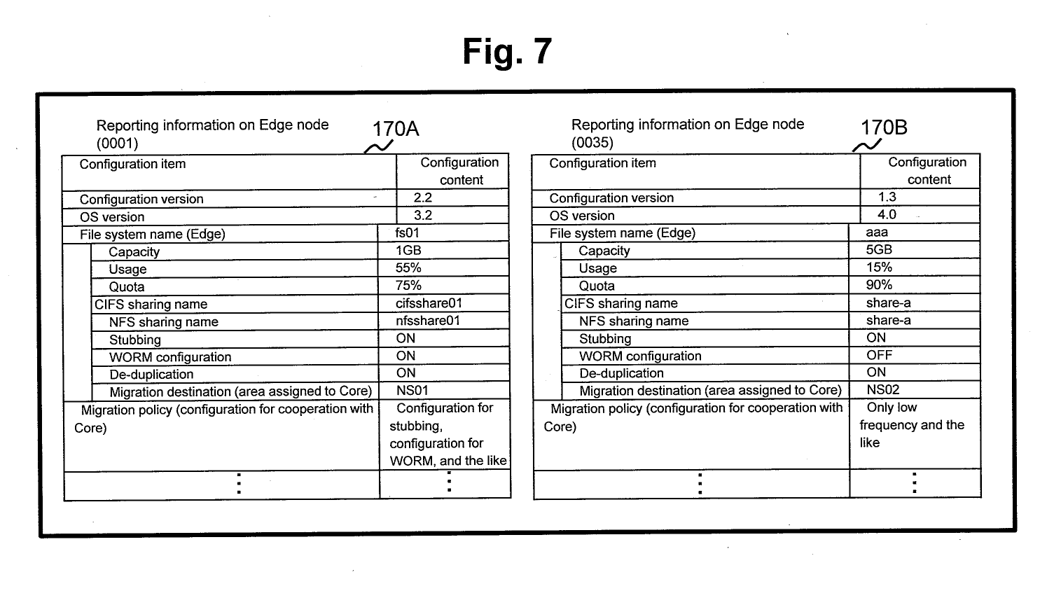

FIG. 7 is a diagram showing reporting information according to the embodiment.

Reporting information 170A is an example of reporting information configured using the configuration information 139A in FIG. 6 and transmitted by the edge node 20. Reporting information 170B is an example of reporting information configured using the configuration information 139B in FIG. 6 and transmitted by the edge node 20.

The reporting information 170A includes values for the same configuration items as those in the configuration information 139A and measured values for the edge node 10. According to the present embodiment, the measured values include the usage of the capacity of the file system. The reporting information 170B includes values for the same configuration items as those in the configuration information 139B and measured values for the edge node 10. According to the present embodiment, the measured values include the usage of the capacity of the file system.

Now, the operation of the computer system according to the embodiment will be described.

First, processing carried out by the computer system will be described in brief.

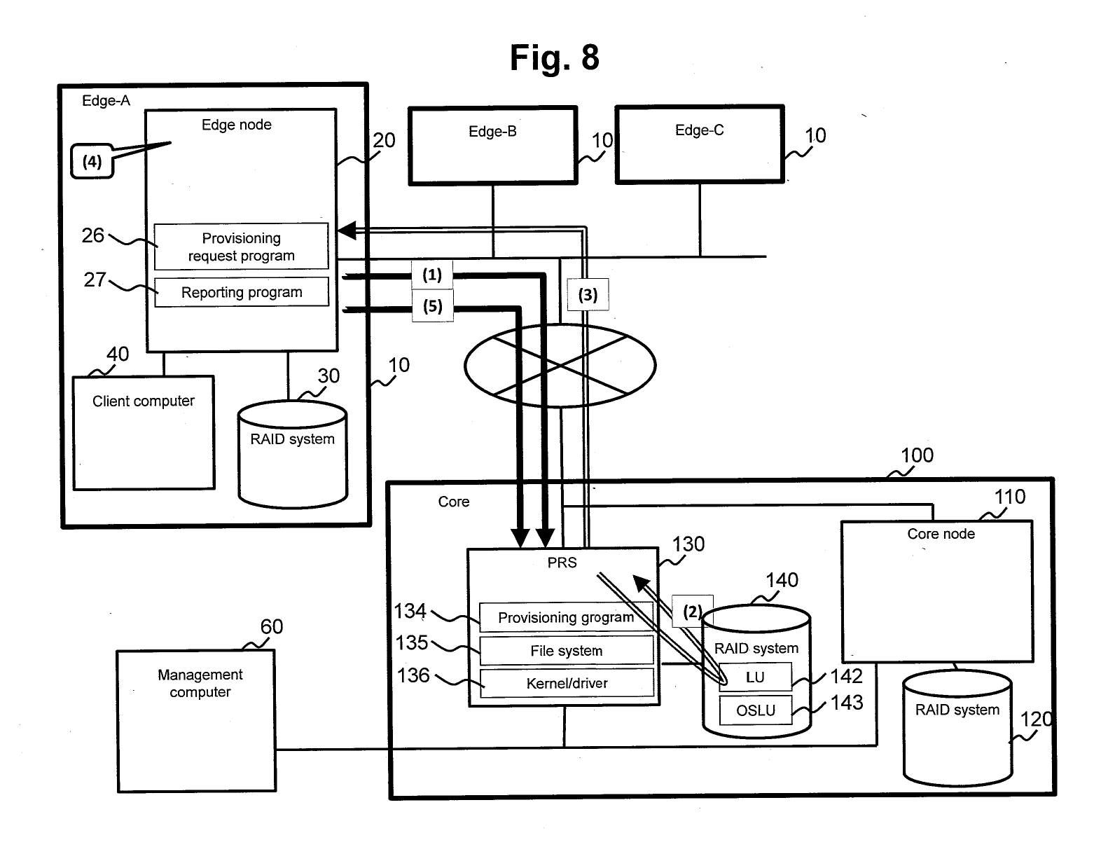

FIG. 8 is a diagram schematically illustrating a provisioning request process according to the embodiment.

The provisioning request process includes requesting configuration information from the edge node 20 at the edge 10 and performing configuration. The provisioning request process is carried out, for example, when a new edge 10 is coupled to the computer system. FIG. 8 shows an example in which an edge-A is newly coupled to the computer system.

The provisioning request program 26 in the edge node 20 at the edge-A transmits a provisioning request to the PRS 130 ((1) in FIG. 8).

Upon receiving the provisioning request, the PRS 130 acquires configuration information for the edge-A from the LU 142 in the RAID system 140 ((2) in FIG. 8).

Then, the PRS 130 transmits the acquired information to the edge node 20, which has made the provisioning request ((3) in FIG. 8).

Upon receiving the configuration information, the edge node 20 at the edge-A configures a file system and the like based on the received configuration information ((4) in FIG. 8). Thus, the edge node 20 is configured based on the configuration information configured in the PRS 130. Subsequently, if the configuration is completed, the edge node 20 transmits a notification indicating that the configuration is completed (configuration completion notification) to the PRS 130 ((5) in FIG. 8).

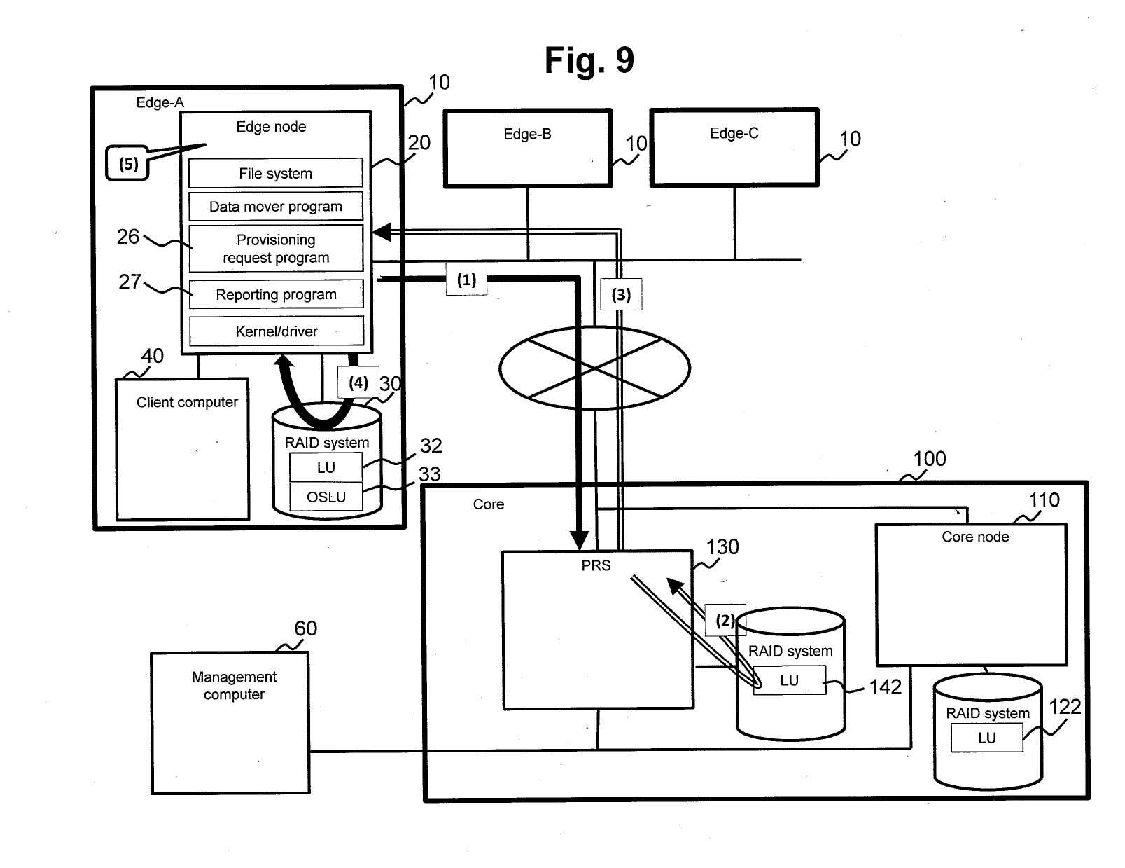

FIG. 9 is a diagram schematically illustrating a reporting process according to the embodiment.

The reporting process is a process of providing a notification of the configuration information on the edge node 20 and the status information on the edge node 20 and is carried out, for example, every predetermined time.

The reporting program 27 in the edge node 20 at the edge-A creates reporting information on the edge node 20 and transmits the reporting information to the PRS 130 ((1) in FIG. 9).

Upon receiving the reporting information, the PRS 130 acquires the latest configuration information for the edge node 20 having transmitted the reporting information, from the LU 142 in the RAID system 140 ((2) in FIG. 9). Specifically, for example, one or more pieces of configuration information are stored in the LU 142 for each edge node 20. The PRS 130 acquires the latest configuration information from the one or more pieces of configuration information corresponding to the edge node 20 having transmitted the reporting information. The latest configuration information on the edge node 20 having transmitted the reporting information refers to a piece of configuration information having the latest configuration version, of the one or more pieces of configuration information corresponding to the edge node 20 having transmitted the reporting information.

Then, the PRS 130 transmits the configuration version (latest configuration version) of the acquired latest configuration information to the edge node 20 having transmitted the reporting information ((3) in FIG. 9).

Upon receiving the latest configuration version, the edge node 20 at the edge-A acquires the current configuration version from the LU 32 in the RAID system 30 ((4) in FIG. 9).

Then, the edge node 20 compares the acquired configuration version with the latest configuration version ((5) in FIG. 9).

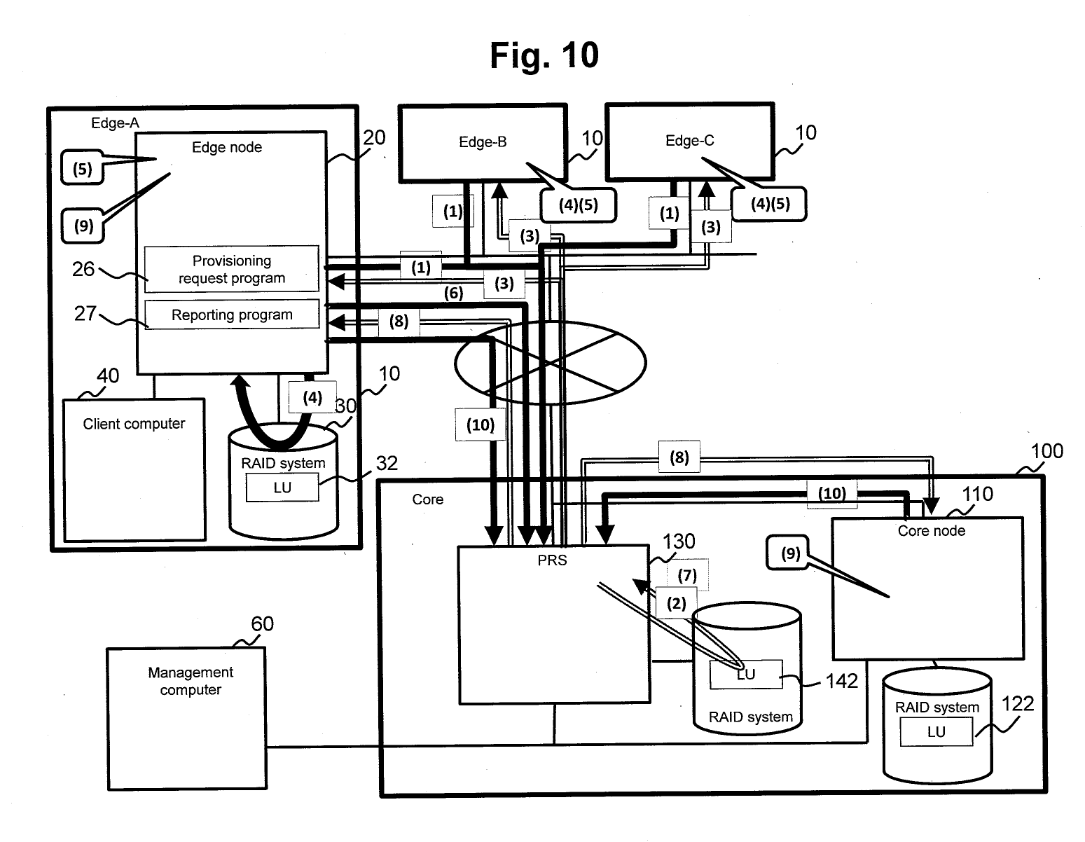

FIG. 10 is a diagram schematically illustrating a process into which the reporting process and the provisioning request process according to the embodiment are combined.

The process shown in FIG. 10 carries out the reporting process, and if the configuration information needs to be changed, carries out the provisioning request process.

In the example shown in FIG. 10, it is assumed that the configuration version for the edge node 20 at the edge-A is not latest but that the configuration version for the edge nodes 20 of an edge-B and an edge-C is latest.

The reporting program 27 in the edge node 20 at each of the edge-A, the edge-B, and the edge-C creates reporting information on the edge node 20 and transmits the reporting information to the PRS 130 ((1) in FIG. 10).

Upon receiving the reporting information, the PRS 130 acquires the latest configuration information (in the example shown in FIG. 10, the latest configuration information for the file server at each of the edge-A, the edge-B, and the edge-C) for the edge node having transmitted the reporting information, from the LU 142 in the RAID system 140 ((2) in FIG. 10).

Then, the PRS 130 determines the configuration version of the acquired configuration information to be the latest configuration version and transmits the configuration version to the edge node 20 (the file server at each of the edge-A, the edge-B, and the edge-C) corresponding to the configuration information ((3) in FIG. 10). Thus, each of the edge nodes 20 having transmitted the reporting information can be allowed to know the latest configuration version.

Upon receiving the latest configuration version, the edge node 20 at each of the edge-A, the edge-B, and the edge-C acquires the current configuration version from the LU 32 in the RAID system 30 ((4) in FIG. 10). Then, the edge node 20 compares the acquired configuration version with the latest configuration version ((5) in FIG. 10).

According to the present embodiment, the edge node 20 at the edge-A determines the configuration version not to be latest, whereas the edge node 20 at each of the edge-B and the edge-C determines the configuration version to be latest.

Then, the edge node 20 (in the example shown in FIG. 10, the edge node 20 at the edge-A) having determined the configuration version not to be latest transmits a provisioning request to the PRS 130 ((6) in FIG. 10).

Upon receiving the provisioning request, the PRS 130 acquires configuration information for the edge-A from the LU 142 in the RAID system 140 ((7) in FIG. 10).

Then, the PRS 130 transmits the acquired configuration information to the edge node 20 having made the provisioning request ((8) in FIG. 10).

Upon receiving the configuration information, the edge node 20 at the edge-A configures a file system and the like based on the received configuration information ((9) in FIG. 10). Thus, the edge node 20 is configured based on the latest configuration information configured in the PRS 130. Subsequently, if the configuration is completed, the edge node 20 transmits a notification indicating that the configuration is completed (configuration completion notification) to the PRS 130 ((10) in FIG. 10). Such processing eliminates the need for the administrator at the edge 10 to configure the edge node 20. Furthermore, the periodic reporting allows the status of each edge node to be determined so that the optimum configuration can be applied to each edge node based on the reporting information. Thus, every edge node can be continuously operated at the same level.

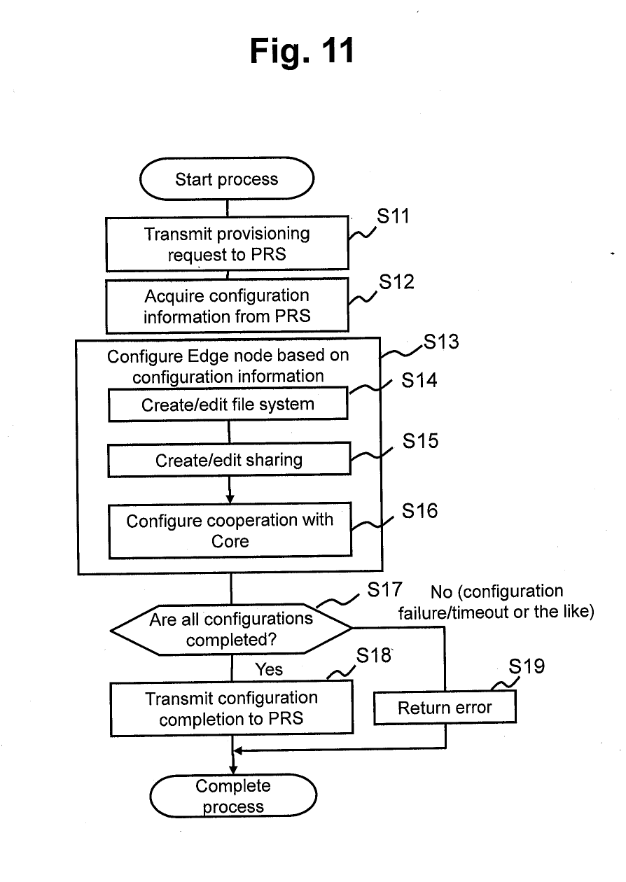

FIG. 11 is a flowchart of the provisioning request process carried out by the edge node according to the embodiment.

The provisioning request program 26 in the edge node (file server) 20 transmits a provisioning request to the PRS 130 (step S11). Here, the provisioning request includes the serial number of the edge node 20 and an authentication token. The authentication token is obtained when the edge node 20 is initially authenticated to the PRS 130 using the serial number and a password.

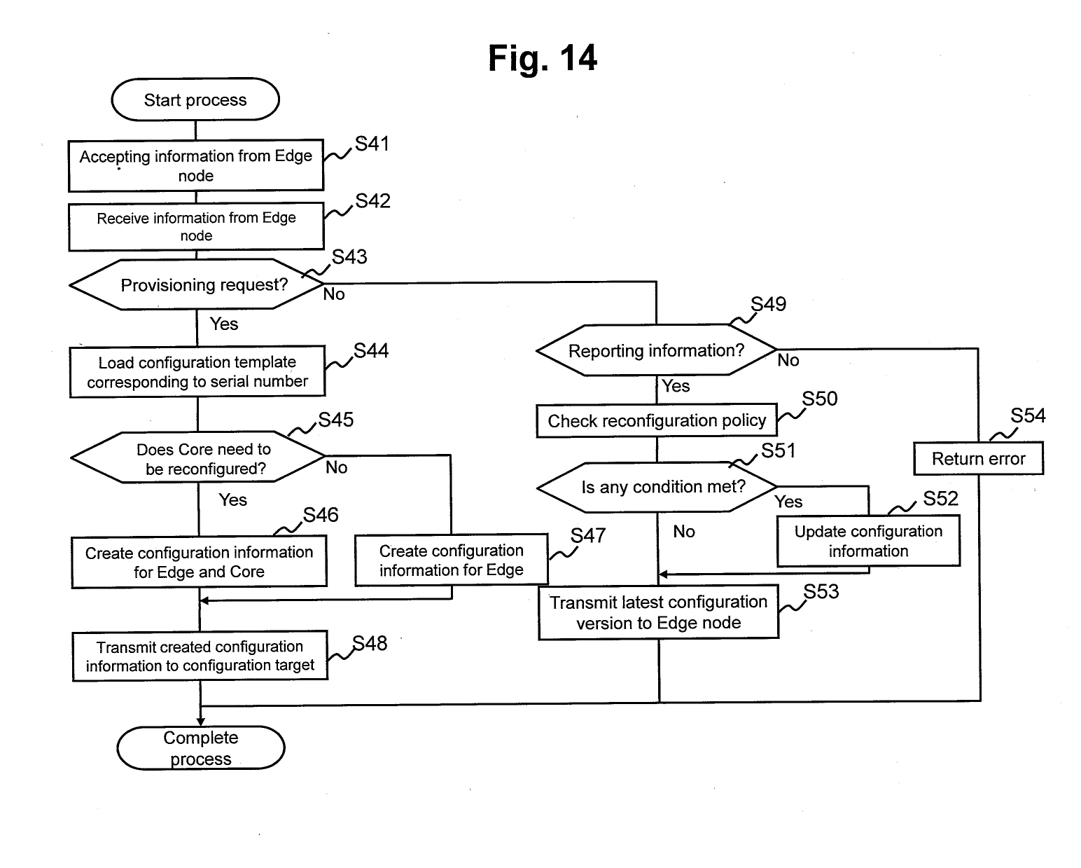

Upon receiving the provisioning request, the PRS 130 returns configuration information for the edge node 20 in a configuration control process (see FIG. 14).

The provisioning request program 26 receives the configuration information returned by the PRS 130 (step S12). Then, the provisioning request program 26 carries out a process of configuring the edge node based on the configuration information (step S13). First, the provisioning request program 26 creates/edits a file system based on the configuration information (step S14). Specifically, the provisioning request program 26 creates/edits a file system name of a file system name included in the configuration information so that a file system has a capacity indicated in the configuration information. The provisioning request program 26 then creates/edits sharing of the file system (step S15). Specifically, the provisioning request program 26, for example, creates a shared directory using a CIFS sharing name and an NFS sharing name included in the configuration information. The provisioning request program 26 then configures core cooperation (step S16). Specifically, the provisioning request program 26 performs configuration corresponding to the content of a configuration for a migration policy included in the configuration information.

Then, the provisioning request program 26 determines whether or not all configurations based on the configuration information are completed (step S17). If all the configurations are completed (Yes in step S17), the provisioning request program 26 transmits a configuration completion notification to the PRS 130 (step S18) to end the process. On the other hand, if not all the configurations are completed, that is, if, for example, a configuration failure or timeout occurs (No in step S17), the provisioning request program 26 transmits an error notification to the PRS 130 (step S19) to end the process.

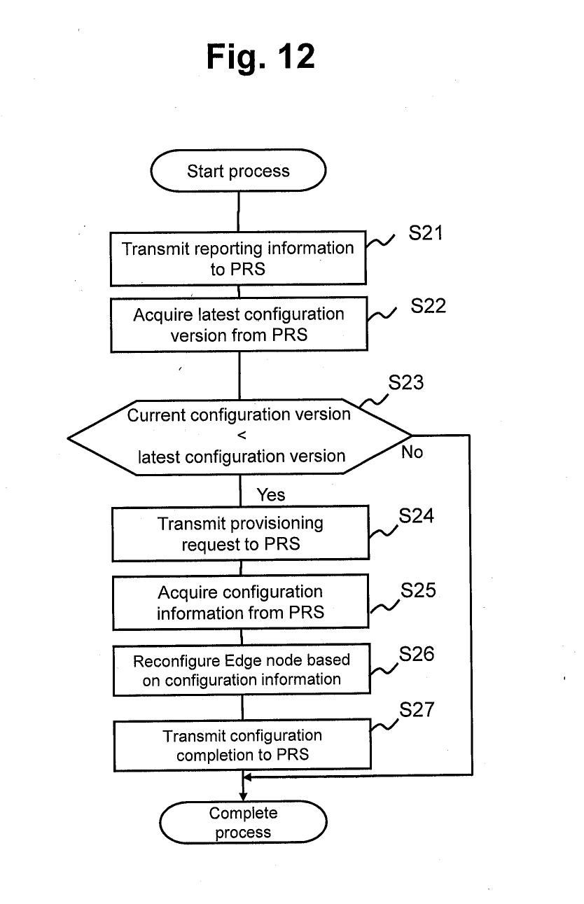

FIG. 12 is a flowchart of the reporting process carried out by the edge node according to the embodiment.

The reporting (reporting) process is carried out, for example, every predetermined time.

The reporting program 27 in the edge node 20 transmits reporting information to the PRS 130 (step S21). Upon receiving the reporting information, the PRS 130 returns the latest configuration version to the edge node 20 in the configuration control process (see FIG. 14).

The reporting program 27 receives the latest configuration information returned by the PRS 130 (step S22). Then, the reporting program 27 determines whether or not the current configuration version for the edge node 20 is smaller than the received latest configuration version, that is, the current configuration version is old (step S23).

If the result of the determination indicates that the current configuration version for the edge node 20 is smaller than the received latest configuration version (Yes in step S23), this means that the configuration of the edge node 20 is not latest. Thus, the provisioning request program 26 transmits a provisioning request to the PRS 130 (step S24). This enables the latest configuration information to be acquired from the PRS 130.

Upon receiving the provisioning request, the PRS 130 returns the latest configuration information for the edge node 20 during the configuration control process (see FIG. 14).

The provisioning request program 26 receives the configuration information returned by the PRS 130 (step S25). The provisioning request program 26 then carries out a process of reconfiguring the edge node 20 based on the configuration information (step S26). The provisioning request program 26 then transmits a configuration completion notification to the PRS 130 (step S27) to end the process. Thus, the edge node 20 can be reconfigured to have the latest configuration.

If the current configuration version of the edge node 20 is not smaller than the received latest configuration version (No in step S23), this means that the configuration of the edge node 20 is the latest. Thus, the reporting program 27 ends the process without doing anything.

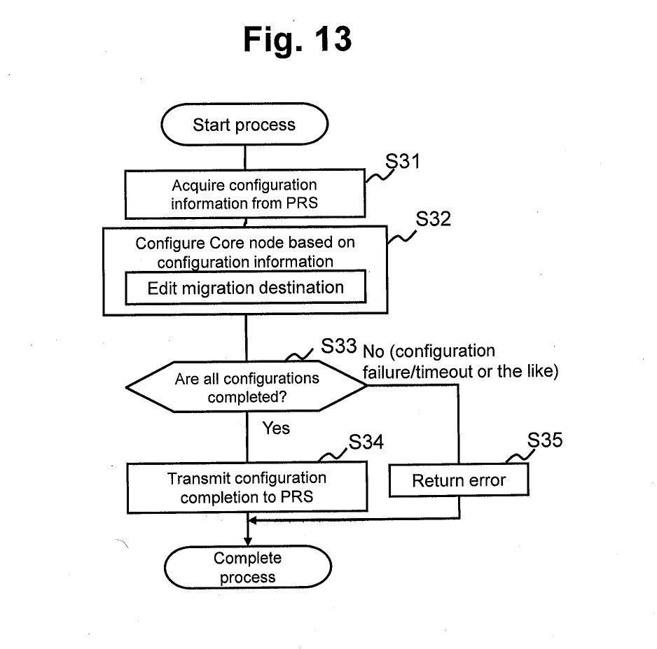

FIG. 13 is a flowchart of a configuration process carried out by the core node according to the embodiment.

Upon receiving configuration information transmitted by the PRS 130 (step S31), the CPU 111 of the core node 110 (core node) carries out a process of configuring the core node 110 based on the received configuration information (step S32). Specifically, for example, the CPU 111 edits a migration destination of the file system based on the configuration information.

Then, the CPU 111 determines whether or not all configurations based on the configuration information are completed (step S33). If all the configurations are completed (Yes in step S33), the CPU 111 transmits a configuration completion notification to the PRS 130 (step S34) to end the process. On the other hand, if not all the configurations are completed, that is, if, for example, a configuration failure or timeout occurs (No in step S33), the CPU 111 transmits an error notification to the PRS 130 (step S35) to end the process.

FIG. 14 is a flowchart of a configuration control process carried out by the provisioning server according to the embodiment.

The provisioning program 134 in the PRS 130 is ready to accept information from edge node 20 (step S41). Then, upon receiving information from the edge node 20 (step S42), the provisioning program 134 determines whether or not the received information is a provisioning request (step S43).

If the result of the determination indicates that the received information is a provisioning request (Yes in step S43), the provisioning program 134 refers to the edge management table 137 to identify and acquire configuration information corresponding to a serial number included in the provisioning request (step S44). The provisioning program 134 then determines whether or not to reconfigure the core node (step S45). For example, if the capacity of the file system in the edge node is larger than the capacity of a name space in the core node to which the file system is to be migrated, the provisioning program 134 determines that the core need needs to be reconfigured in order to increase the capacity of the name space. In addition, the core node needs to be reconfigured if a new function has been enabled in the edge node and is also to be enabled in the core node or if the area of the tenant or name space in the core node is to be released when the edge node is inactivated and initialized.

If the result of the determination indicates that the core node needs to be reset (Yes in step S45), the provisioning program 134 creates configuration information for each of the edge node 20 and the core node 110 (step S46), and advances the process to step S48. On the other hand, if the core node 110 need not be reconfigured (No in step S45), the provisioning program 134 creates configuration information for the edge node 20 (step S47) and advances the process to step S48. In step S48, the provisioning program 134 transmits the configuration information created in step S46 or step S47 to a configuration target (edge node 20 and/or core node 110) to end the process. Thus, the appropriate configuration information can be transmitted to the edge node 20 and/or the core node 110 for configuration.

On the other hand, if the received information is not a provisioning request (No in step S43), the provisioning program 134 determines whether or not the received information is reporting information (step S49).

If the result of the determination indicates that the received information is reporting information (Yes in step S49), the provisioning program 134 checks (refers to) a preset reconfiguration policy (step S50) to determine whether or not any of one or more conditions in the reconfiguration policy is met, based on a plurality of information elements of the reporting information and the reconfiguration policy (step S51). Here, for the reconfiguration policy, examples of combinations of a condition and a process carried out when the condition is met will be described below.

(1) (Condition=the version of an OS for another edge node at the edge to which the edge node having transmitted the reporting information belongs is newer than the OS version in the reporting information): (process=the version of the OS for the edge node having transmitted the reporting information is updated to an OS with the newest OS version for the edge to which the edge node having transmitted the reporting information belongs.)
(2) (Condition=hard limit has been exceeded or is likely to be exceeded in the edge node having transmitted the reporting information.): (process=for the edge node having transmitted the reporting information, the quota is changed, the capacity of the file system is increased, or the capacity is reduced by means of stubbing or de-duplication.)
(3) (Condition=the capacity of the file system in the edge node having transmitted the reporting information is larger than the capacity of the name space in the core node to which the file system is to be migrated.): (process=the capacity of the name space in the core node to which the file system is to be migrated is increased above the capacity of the file system in the edge node having transmitted the reporting information.) Whether the condition is met can be determined based on the reconfiguration policy and at least one of (A), (B), and (C) described below.
(A) Received reporting information
(B) Reporting information and at least one piece of configured configuration information on another edge node (for example, an edge node belonging to the same edge) associated with the edge node having transmitted the reporting information.
(C) Reporting information and at least one piece of configured configuration information on the core node (for example, a core node managing the name space to which the file system for the edge node is to be migrated) corresponding to the edge node having transmitted the reporting information.

If the result of the determination indicates that any of the conditions is met (Yes in step S51), the provisioning program 134 updates the configuration information (step S52) and advances the process to step S53, based on the reporting information (specifically, in accordance with the (process) corresponding to the (condition)). Thus, the configuration information can be adjusted to the appropriate configuration value. In step S52, at least one of the following (a) and (b) may be carried out.

(a) The provisioning program 134 changes, based on a predetermined item (for example, a measured value) in the reporting information, a value corresponding to the predetermined item (or one or more items associated with the predetermined item) in the configuration information corresponding to the edge node having transmitted the reporting information.
(b) The provisioning program 134 changes, based on a predetermined item (for example, a measured value) in the reporting information, a value corresponding to the predetermined item (or one or more items associated with the predetermined item) in the configuration information corresponding to edge nodes at edges belonging to the same company to which the edge with the edge node having transmitted the reporting information belongs or an affiliated company. A specific example of step S52 will be described in conjunction with a case where the reconfiguration policy is configured such that the OS version is adjusted to the latest of the OS version for a plurality of edge nodes. First, the provisioning program 134 compares the values of the OS version items included in the reporting information on the edge nodes to be compared with one another to identify the latest OS version. If the latest OS version is different from the OS version configured in the current configuration information, the provisioning program 134 updates the OS version in the configuration information and the value of the configuration version. The configuration version is inevitably updated if the contents of the configuration information are changed. In this state, the process proceeds to step S53, and thus, the configuration version different from the configuration version of the configured configuration information is transmitted to the edge node. This allows a provisioning request to be invited from the edge node. The configuration information configured in S52 is at least one piece of configuration information corresponding to at least one of the edge node having transmitted the reporting information, an edge node associated with the edge node having transmitted the reporting information, and the core node corresponding to the edge node having transmitted the reporting information. The configuration information updated in S52 is information that allows execution of a process corresponding to the condition determined in S51 to be met. The updated version of the configuration information (that is, the latest configuration version)′ is transmitted in S53 to a node corresponding to the updated configuration information (that is, at least one of the edge node having transmitted the reporting information, the edge node associated with the edge node having transmitted the reporting information, and the core node corresponding to the edge node having transmitted the reporting information). The updated configuration information itself may be transmitted in S53 to the node corresponding to the updated configuration information.

Here, the provisioning program 134 may determine the usage of the tenant in the storage area based on the reporting information, and adjust the configuration information based on the usage. This allows configurations in units of tenants to be appropriately adjusted.

On the other hand, if none of the conditions is met (No in step S51), the provisioning program 134 advances the process to step S53. In step S53, the provisioning program 134 transmits the latest configuration version to the edge node 20 (or the core node for which the configuration information with the latest configuration version is to be configured) and subsequently ends the process. The transmission of the latest configuration version to the edge node 20 allows a process of acquiring configuration information to be carried out when necessary during the reporting process (see FIG. 12).

If the result of the determination in step S49 indicates that the request is not reporting information (No in step S49), the provisioning program 134 transmits an error notification to the edge node 20 (step S54) to end the process.

The embodiment has been described. The following is derived from the above description.

(1: The PRS and the Edge Mutually have Configuration Authorities)

In some cases, the PRS 130 takes the initiative in applying information distributed by the PRS 130, and in other cases, the edge node takes the initiative.

(a) Case where the PRS 130 Takes the Initiative in Reflecting Configurations:

The edge node can be forcibly configured, and thus, the same environment can be quickly created for a large number of edge nodes. Furthermore, this case is effective if configuration items are predetermined as in the case of initialization and the like.

(b) Case where the Edge Node Takes the Initiative in Reflecting Configurations:

The edge node can selectively determine whether to reflect the configurations, enabling the configurations to be flexibly implemented according to the environment of the edge node. Furthermore, unwanted configuration reflections such as additions of optional functions and version upgrades can be prevented.

For example, when each edge is introduced, the case (a) is adopted to initialize the edge. On the other hand, while the edge is in operation, the case (b) is adopted so that the edge reflects the configurations.

Furthermore, if, for example, an immediate reflection of the configurations affects service, the PRS 130 may carry out the configuration reflection while the number of users is small, and at the time of the next reactivation, the edge node may carry out the configuration reflection and the like.

Furthermore, the PRS 130 can transmit, to each edge node, a configuration reflection policy that the configurations are reflected if the CPU usage in the reporting information is a predetermined percentage or lower.

Additionally, the case (a) and the case (b) can be flexibly switched. This is because both the PRS 130 and the edge node are file servers.

### (2: Control on the Core Side)

For example, even if a configuration error occurs in an edge node, the PRS 130 can detect the configuration error based on the reporting information from the edge node and transmit the correct configuration information to the edge node to allow the edge node to configure the correct configuration information.

Furthermore, for example, if the PRS 130 determines that an expiration date of an edge node or an optional function has been passed, based on the reporting information from the edge node, the PRS 130 can control values in the configuration information to be transmitted to the edge node to stop the use of the edge node or the optional function.

Additionally, based on the reporting information from an edge node (or if the PRS 130 fails to receive the reporting information according to a schedule indicated in the configuration information corresponding to the edge node), the PRS 130 can reset the configuration of the edge node to its factory default by transmitting configuration information on the factory default to the edge node.

### (3: Effective Use of the Reporting Information)

For example, the PRS 130 can modify the configuration template based on the reporting information. Specifically, for example, if a predetermined item in the reporting information exceeds a predetermined value, the PRS 130 can carry out a process of, for example, dividing the predetermined item into sub-items or adding a related item to the configuration template, on the configuration template.

Furthermore, for example, the PRS 130 can select the optimum configuration information from the reporting information collected from a plurality of edge nodes and allow the edge nodes other than the edge node with the selected configuration information to apply the configuration information (in the embodiment, the configuration information on the latest configuration version).

Additionally, for example, if the PRS 130 determines that an edge node is stably operated based on a plurality of pieces of reporting information received from the same edge node (for example, the CPU usage falls within the appropriate range a predetermined number of times or more), the PRS 130 extends the schedule (reporting interval) indicated in the configuration information corresponding to the edge node. On the other hand, if the PRS 130 determines that the edge node is unstably operated (for example, the CPU usage falls out of the appropriate range a predetermined number of times or more), the PRS 130 shortens the schedule (reporting interval) indicated in the configuration information corresponding to the edge node. Such a configuration enables the reporting to be inhibited from affecting the service.

In addition, for example, if a defect is detected in an edge node based on the reporting information after configurations are reflected, the original normal state can be recovered by applying configuration information with an older configuration version back to the edge node.

The embodiment of the present invention has been described above. However, of course, the present invention is not limited to the embodiment, and various changes may be made to the embodiment without departing from the spirits of the present invention.

### REFERENCE SIGNS LIST

10 Edge
20 File server (edge node)
100 Core
110 Archive storage device (core node)
130 Provisioning server

1. An environment configuration server provided in a remote system in a computer system including a plurality of local file servers present in a local system, and a remote file server present in the remote system and coupled to the plurality of local file servers, the environment configuration server comprising:
a communication interface device coupled to the plurality of local file servers; and
a processor coupled to the communication interface device,
wherein the processor is configured to
identify, from a storage device storing environment configuration information regarding an environment configuration for each of the plurality of local file servers, environment configuration information corresponding to a configuration-target local file server of the plurality of local file servers, and
transmit the identified environment configuration information to the configuration-target local file server.

2. An environment configuration server according to claim 1,
wherein the processor is configured to
receive, from each of the plurality of local file servers, a report indicating an operational status of the local file server, and
notify the local file server having transmitted the report of a version of the environment configuration information stored in the storage device.

3. An environment configuration server according to claim 1,
wherein the processor is configured to
receive, from each of the plurality of local file servers, a report indicating an operational status of the local file server,
determine, based on a policy including one or more conditions and at least one of the followings (A) to (C), whether or not any of conditions is met is included in the policy, and
(A) the received report,
(B) at least one of a report on a local file server associated with the local file server having transmitted the report in (A), and configured environment configuration information, and
(C) at least one of a report on a remote file server corresponding to the local file server having transmitted the report in (A), or configured environment configuration information,
when a result of the determination is true, update environment configuration information corresponding to at least one of the local file server having transmitted the report in (A), the local file server associated with the local file server having transmitted the report in (A), and the remote file server corresponding to the local file server having transmitted the report in (A), and notify a server corresponding to the updated environment configuration information of a version of the updated environment configuration information or the updated environment configuration information.

4. An environment configuration server according to claim 2,
wherein the processor is configured to update the environment configuration information for at least one of the local file server having transmitted the report, and the local file server associated with the local file server having transmitted the report.

5. An environment configuration server according to claim 1, which is configured in an identical computer in which the remote file server is configured.

6. An environment configuration server according to claim 1,
wherein the processor is configured to
receive a transmission request for the environment configuration information from the local file server; and
upon receiving the transmission request, transmit the environment configuration information corresponding to the local file server having transmitted the transmission request, to the local file server.

7. An environment configuration server according to claim 2, wherein the processor is configured to change a configuration for the remote file server based on the report.

8. An environment configuration server according to claim 1,
wherein the storage device is configured to store a configuration template including a configuration item for the environment configuration for the local file server, and
wherein the processor is configured to receive a configuration value for the configuration item in the configuration template, generate the environment configuration information by reflecting the configuration value in the configuration template, and store the generated environment configuration information in the storage device.

9. An environment configuration server according to claim 1,
wherein the remote file server is configured to manage a storage area to which a file managed by the local file server is migrated,
wherein the storage area includes a sub-storage area to which a file managed by one or more of the local file servers is migrated, and
wherein the processor is configured to determine a usage of the sub-storage area in the storage area based on information in the report and to adjust the environment configuration information based on the usage.

10. A computer system comprising:
a local system including a plurality of local file servers; and
a remote system coupled to the local system and including a remote file server coupled to the plurality of local file servers, and an environment configuration server configured to control environment configurations for the plurality of local file servers,
wherein the environment configuration server is configured to
identify, from a storage device storing environment configuration information regarding an environment configuration for each of the plurality of local file servers, environment configuration information corresponding to a configuration-target local file server of the plurality of local file server; and
transmit the identified environment configuration information to the configuration-target local file server, and
wherein the configuration-target local file server is configured to receive the environment configuration information and carry out environment configuration based on the received environment configuration information.

11. A computer system according to claim 10,
wherein each of the plurality of local file servers is configured to transmit a report indicating an operational status of the local file server to the environment configuration server, and
wherein the environment configuration server is configured to receive the report and notify the local file server having transmitted the report of a latest version of the environment configuration information.

12. A computer system according to claim 11,
wherein the local file server is configured to request the latest version of the environment configuration information from the environment configuration server when aversion of the environment configuration information on the local file server is older than the latest version from the environment configuration server.

13. An environment configuration method carried out in a computer system comprising a plurality of local file servers present in a local system, and a remote file server present in a remote system and coupled to the plurality of local file servers, the method comprising:
identifying, from a storage device storing environment configuration information regarding an environment configuration for each of the plurality of local file servers, environment configuration information corresponding to a configuration-target local file server of the plurality of local file server; and
transmitting the identified environment configuration information to the configuration-target local file server.
